(19) United States
(12) Patent Application Publication
(10) Pub. No.: US 2022/0316825 A1
(43) Pub. Date: Oct. 6, 2022

(54) WORKING FLUID EVAPORATOR FOR AN OTEC PLANT, COMPRISING IN PARTICULAR A REDISTRIBUTION SYSTEM

(71) Applicant: NAVAL GROUP, Paris (FR)

(72) Inventor: Bertrand CLAUZADE, Paris (FR)

(21) Appl. No.: 17/596,738

(22) PCT Filed: Jun. 16, 2020
(86) PCT No.: PCT/EP2020/066611

§ 371 Date: Dec. 16, 2021

(30) Foreign Application Priority Data
Jun. 17, 2019 (FR) FR1906466

(51) Int. Cl. F28F 25/04; F22B 15/00; F22B 1/16; B01D 1/04; B01D 1/20

(52) U.S. Cl. CPC F28F 25/04; F22B 15/00; F22B 1/16; B01D 1/04; B01D 1/20; F28F 2025/005

(57) ABSTRACT

The present invention relates to a working fluid evaporator for an OTEC plant, comprising an evaporator body extending along a longitudinal axis, a bundle of evaporators transporting hot water and comprising a plurality of evaporation elements, a sprinkling system extending above the bundle of evaporators and a casing covering the bundle of evaporators and the sprinkling system, an evacuation area being formed between end columns of the evaporator elements and the casing. The evaporator further comprises a redistribution system configured to collect the working fluid in a liquid state in the evacuation area and direct it to interior evaporator elements.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present invention relates to a working fluid evaporator for an OTEC plant, comprising in particular a redistribution system.

### BACKGROUND

In a manner known per se, an OTEC plant uses the temperature difference between the surface water and the deep water of the oceans to produce electricity.

Typically, such a OTEC plant comprises an evaporator wherein a working fluid is evaporated by the warm surface waters to drive a turbine, and a condenser in which this working fluid is then condensed by the cold waters of the ocean floor.

The evaporator of an OTEC plant generally has an elongated body through which a bundle of evaporators extends. This bundle of evaporators, in the form of a plurality of evaporator elements such as pipes or plates, circulates hot water along the evaporator. The evaporator elements thus form a plurality of columns, each column extending from the upper part of the evaporator to its lower part.

A sprinkling system, consisting of pipes and nozzles mounted on the pipes, is provided along this bundle in order to sprinkle the working fluid, in a liquid state, onto it.

The evaporator body, also known as the shell in the state of the art, not only acts as a pressurized container but also guides the working fluid evaporated by the bundle of evaporators to an evacuation system.

In horizontal falling film evaporator applications, the sprinkling system is located below the evacuation system. Thus, the fluid in liquid state falling by gravity on the bundle of evaporators rises again after evaporation to the evacuation system.

A cover, also known as a casing, is generally provided to direct the steam towards the evacuation system.

This casing covers the sprinkling system and the bundle of evaporators, thus defining a passage for steam with the shell.

When passing through the bundle of evaporators, the non-evaporated working fluid flows from an upper evaporator element to a lower evaporator element.

This runoff does not take place fully vertically when the flow rate of the non-evaporated fluid exceeds a certain value. Thus, the runoff deviates from the vertical axis and reaches the evaporator elements of adjacent columns.

This phenomenon does not pose a problem in the core of the bundle because the adjacent deflections compensate each other. However, the deviated runoff from the end columns reaches the casing where the fluid flows without being evaporated. This phenomenon corresponds to an edge effect that is detrimental to the operation of the plant.

In order to correct the edge effect, some methods in the state of the art propose to increase the fluid feed rate. However, this leads to an increased power consumption of the recirculation pumps.

### SUMMARY

The object of the present invention is to correct the edge effect without causing excessive power consumption.

To this end, the invention has as its object a working fluid evaporator for an OTEC plant, comprising:
an elongated evaporator body extending along a longitudinal axis and defining an upper part and a lower part, a transverse axis extending between the upper part and the lower part perpendicularly to the longitudinal axis;
a bundle of evaporators transporting hot water and comprising a plurality of evaporator elements extending along the longitudinal axis, the evaporator elements forming columns extending along the transverse axis, with each column adjacent to two other columns referred to as an interior column and each column adjacent to only one other column being referred to as an end column;
a sprinkling system extending above the bundle of evaporators in the upper part of the evaporator body and adapted to sprinkle the working fluid in liquid state onto the bundle of evaporators to evaporate this working fluid;
a casing covering the bundle of evaporators and the sprinkling system, an evacuation area being formed between the end columns and the casing;
the evaporator being characterized in that it further comprises a redistribution system configured to collect the working fluid in liquid state in the evacuation area and direct it towards the interior columns.

According to other advantageous aspects of the invention, the evaporator comprises one or more of the following features, taken alone or in any technically possible combination:
the redistribution system comprises a plurality of bent sheets, each sheet comprising a first part extending transversely along the transverse axis and a second part bent relative to the first part and directed towards the interior columns;
the first part of each sheet forms an angle greater than 90° and less than 180° with the second part of that same sheet;
the first part and/or the second part of each is/are substantially planar;
the bundle of evaporators further comprises support bars adjacent to each end column and extending along the longitudinal axis;
at least one sheet further comprises a third part configured to attach the sheet to one of the support bars, advantageously the third part forming a means of hooking the sheet to the corresponding support bar;
the third part of the corresponding metal sheet is located as an extension of the first part opposite the second part;
the casing forms a side wall adjacent to each end column, each sheet being adjacent to one of the side walls of the casing;
the first part of each sheet is integral with or forms at least part of the corresponding side wall of the casing;
the first parts of the sheets form the side walls of the casing;
each sheet extends longitudinally along the longitudinal axis along the evaporator elements of the evaporator bundle; and
for each end column, a plurality of sheets are arranged one after the other along the transverse axis, the second parts of these sheets being substantially parallel to each other.

### BRIEF DESCRIPTION OF THE DRAWINGS

These features and advantages of the invention will become apparent from the following description, given only as a non-limiting example, and made with reference to the appended drawings, in which:

FIG. 1 is a schematic side view of an evaporator according to the invention, the evaporator comprising a redistribution system;

FIG. 2 is a schematic cross-sectional view of the evaporator in FIG. 1 according to the sectional plane II-II visible in this FIG. 1; and

FIG. 3 is an enlarged view of detail III of FIG. 2.

### DETAILED DESCRIPTION

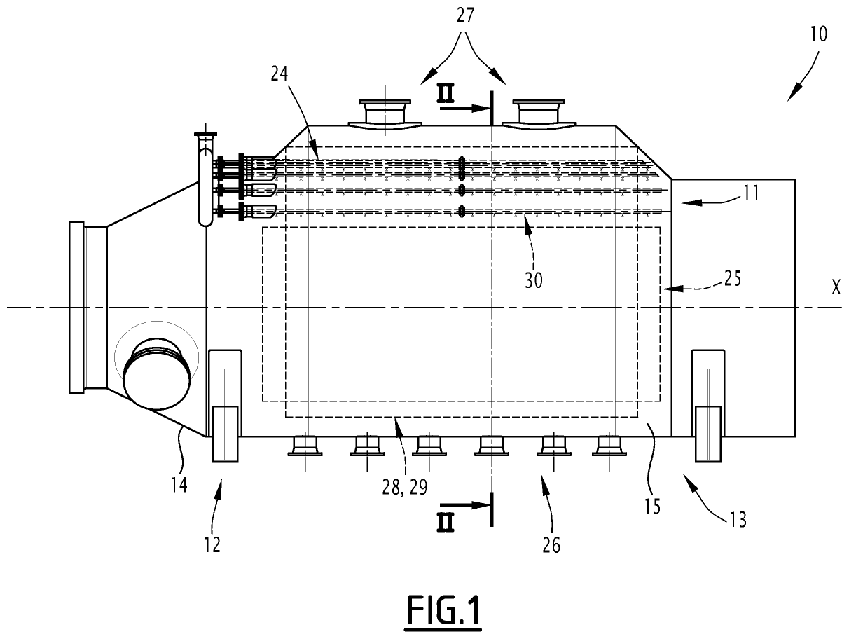

In fact, an evaporator 10 for an OTEC plant has been shown in FIG. 1. In the illustrated example, the evaporator 10 is a pipe evaporator. However, the invention remains applicable to a plate evaporator when, several vertical plates form the height of the bundle of evaporators, for example.

With reference to FIG. 1, the evaporator 10 has an evaporator body 11 extended along a longitudinal axis X between a first end 12 and a second end 13.

At the first end 12, the evaporator body 11 has a substantially conical shape 14 opening into a substantially cylindrical shape 15 defining the second end 13.

The evaporator body 11 is pressurized, for example, and may also be referred to in the terminology used in the prior art as a shell.

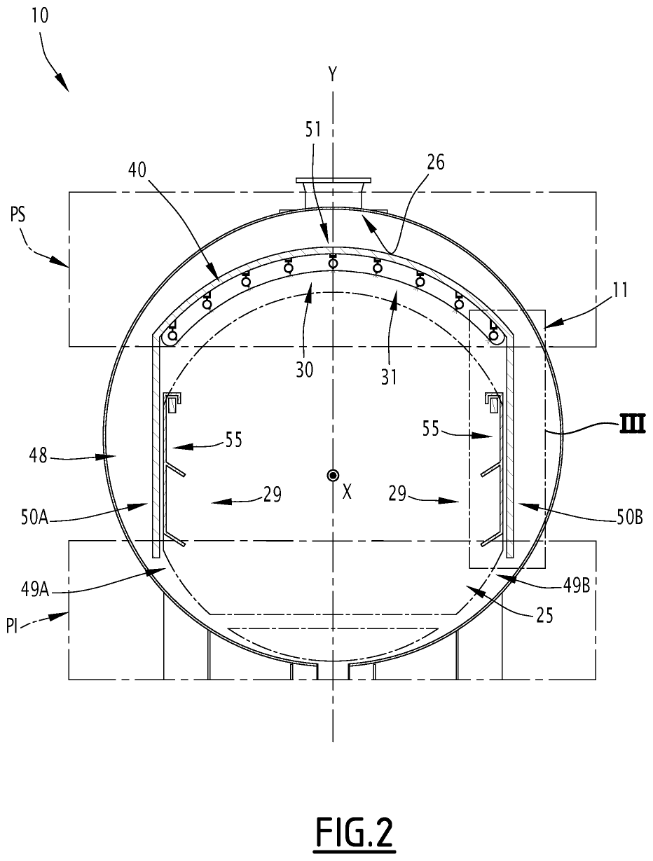

The evaporator body 11 defines an upper part PS and a lower part PI visible in FIG. 2 showing a cross section of the cylindrical part 15.

The evaporator body 11 further defines a transverse axis Y extending between the upper part PS and the lower part PI perpendicular to the longitudinal axis X. Notably, this transverse axis Y is perpendicular to the horizontal plane containing the longitudinal axis X.

Referring again to FIG. 1, the evaporator 10 comprises a sprinkling system 24, a bundle of evaporators 25, a channeling system 26, an evacuation system 27, a guiding system 28 and a redistribution system 29.

The sprinkling system 24 is arranged in the upper part PS of the evaporator body 11 and comprises a supply network and a plurality of sprinkling nozzles arranged on this supply network.

In particular, in the example of FIGS. 1 and 2, the supply network takes the form of a plurality of supply pipes 30.

Within the evaporator body 11, each supply pipe 30 extends along the longitudinal axis X above the bundle of evaporators 25. Thus, in FIG. 1, the parts of these pipes extending inside the body 11 are shown as broken lines and the parts extending outside the body 11 are shown as solid lines.

Furthermore, as can be seen in cross-section in FIG. 2, the supply pipes 30 are arranged on an arc of a circle 31. This arc 31 is formed by suitable support means. arranged at each end 12, 13 of the evaporator body 11, for example.

The opening of this arc of a circle 31 is between 80° and 160°, for example.

In addition, the supply pipes 30 are for example evenly distributed along this arc.

Thus, in the example shown in FIG. 2, nine supply pipes 30 distributed homogeneously along the arc 31 are shown.

The bundle of evaporators 25 takes the form of a plurality of evaporator elements having in the described example pipes passing through the cylindrical part 15 of the body 11 along the longitudinal axis X. As previously described, the evaporator elements may also have plates.

The evaporation pipes are a few thousand in number, for example, such as 3000 in number. Thus, for reasons of legibility of FIGS. 1 and 2, these pipes are not shown there.

The pipes of the bundle of evaporators 25 are arranged below the sprinkling system 24 and form a plurality of columns extending along the transverse axis Y.

Thus, each column is adjacent to two other columns or to only one other column. In the former case, this column is referred to as the interior column and in the latter case, this column is referred to as the end column.

In particular, it is clear that in the example shown in FIG. 2, two end columns are formed.

The pipes of the bundle of evaporators 25 transport water, called warm water, i.e. surface water. This water circulates in the bundle of evaporators 25 along the main axis X, from left to right in the example of FIG. 1, for example.

Thus, when a working fluid sprinkled via the sprinkling system 24 comes into contact with the pipes of the bundle 25, it vaporizes.

The bundle of evaporators 25 further comprises support bars adjacent to each end column and extending along the longitudinal axis X. These support bars are even spaced along the transverse axis Y, for example, and allow the pipes of the bundle of evaporators 25 to be attached to the evaporator body 11.

The channeling system 26 allows the non-vaporized working fluid to be channeled back into the evaporator 10 via the sprinkling system 24, for example.

This channeling system 26 is arranged in the lower part PI of the evaporator body 11, below the evaporator bundle 25.

The evacuation system 27 is used to evacuate steam produced by the bundle of evaporators 25 and to guide it to a (non-illustrated) turbine for rotation.

This evacuation system 27 is arranged in the upper part PS of the evaporator body 11, above the sprinkling system 24 and thus, above the bundle of evaporators 25.

The evacuation system 27 takes the form of a plurality of channels passing through the evaporator body 11 in the upper part thereof, for example.

The guiding system 28 is used to guide the working fluid in a gaseous state to the evacuation system 27.

For this purpose, the guiding system 28 comprises an elongated casing 40 extending along the central axis X. This casing covers the bundle of evaporators 25 and the sprinkling system 24.

The casing 40 is arranged at a distance from the inner surface of the evaporator body 11 so as to form a channel 48 for the passage of the steam to the evacuation system 27.

This channel 48 opens in the lower part PI of the evaporator body 11 onto two longitudinal openings 49A, 49B, formed between the casing 40 and the interior interface of the evaporator body 11. Each of these openings 49A, 49B thus extends along the entire length of the casing 40 along the longitudinal axis X.

The casing 40 defines two side walls 50A, 50B extending along the transverse Y and longitudinal X axes on either side of the bundle of evaporators 25 and a curved wall 51 extending between the side walls 50A, 50B above the sprinkling system 24.

Each side wall 50A, 50B is substantially flat in shape, for example.

Furthermore, each side wall 50A, 50B is adjacent to one of the end columns of the bundle of evaporators 25 while forming an evacuation area 55 with that end column.

In particular, as the working fluid passes through the bundle of evaporators 25, some runoff of the working fluid in liquid state avoids the end columns and is conducted in this space 55.

The redistribution system 29 is located in the evacuation area 55 and is configured to collect the non-evaporated working fluid in this space 55 to direct it to the core of the bundle of evaporators 25, i.e., to the interior columns of this bundle.

To do so, the redistribution system 29 comprises a plurality of flexed plates, each plate extending longitudinally along the length of the bundle of evaporators 25 along the longitudinal axis X.

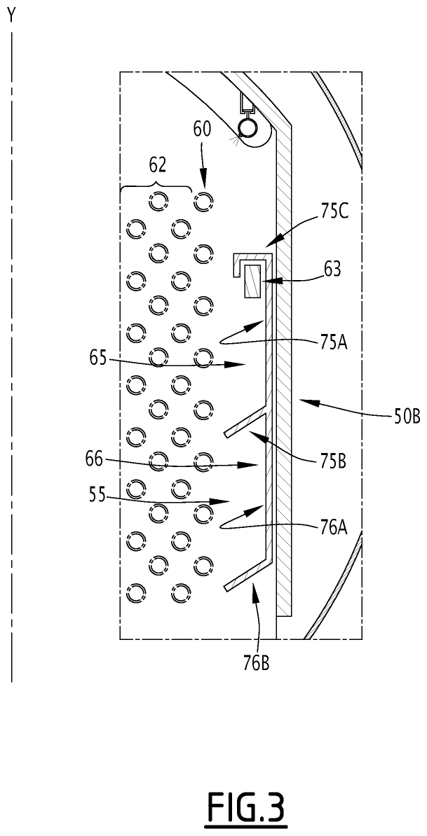

A part of this system 29 is visible in FIG. 3 showing enlarged detail III of FIG. 2.

In particular, in this FIG. 3, an end column 60 and two interior columns 62 are visible. Furthermore, a support bar 63 for the pipes of the bundle of evaporators 25 is also visible.

In addition, two sheets 65, 66, of the set of sheets of the redistribution system 29, are visible in FIG. 3.

Each of the sheets 65, 66 comprises a respective first part 75A, 76A, extending transversely along the transverse axis Y and a respective second part 75B, 76B, bent from the first part 75A, 76A and directed toward the interior columns.

Thus, the second parts 75B, 76B are configured to capture runoff of the working fluid in liquid state in the space 55 to direct it toward the interior columns 62.

In particular, the first part 75A, 76A of each sheet 65, 66 forms an angle of between 90° and 180°, advantageously between 120° and 160° and preferably between 130° and 150°, with the second part 75B, 76B of that same sheet 65, 65.

The junction between the first part 75A, 76A and the second part 75B, 76B of each sheet 65, 66 forms a fold or a bend, for example, depending on the bending experienced by the sheets.

Each part of each sheet 65, 66 is substantially flat, for example, or has any other shape that favors retrieval of the working fluid in liquid state in the evacuation area 55 and its runoff towards the interior columns 62.

According to one particular example of embodiment of the invention, the first parts 75A, 76A of the plates 65, 66 are fixed or integrated into the corresponding side wall 50B of the casing 40.

According to another example embodiment, these first parts 75A, 76A form at least a part of the corresponding side wall 50B.

In other words, the sidewalls 50A, 50B of the casing 40 in this case are at least partially made of sheets adapted to have the working fluid in a liquid state run off towards the interior columns.

All of the sheets in the system 29 are substantially analogous, for example.

In a variant, at least one of the sheets has a different shape and/or structure than the other sheets.

Thus, in the example of FIG. 3, contrary to the sheet 66, the sheet 65 also comprises a third part 75C located in extension of the first part 75A opposite the second part 75B.

This third part 75C forms, a means for hooking the sheet to the support bar 63, for example.

According to yet another example embodiment, each sheet of the system 29 includes a third part as described above.

Of course, other examples of attachment, fastening or form of the sheets are also possible. For example, it is possible to attach the third part 75C to the corresponding support bar 63 using bolts and slotted holes to provide differential expansion.

During operation of the evaporator 10, some runoff of the working fluid in liquid state deviates the vertical flow axis. Thus, when this runoff is near the end columns, it pass into the evacuation area 55.

In this space 55, this runoff is collected by the redistribution system 29 and in particular by the second parts 75B, 76B of the plates 65, 66. Then, they are reinjected towards the center of the beam 25.

The redistribution system 29 thus makes it possible to minimize the edge effect without increasing the flow rate of the fluid sprayed, thus without creating an overconsumption of electricity.

1. A working fluid evaporator for an OTEC plant, comprising:
an elongated evaporator body extending along a longitudinal axis and defining an upper part and a lower part, a transverse axis extending between the upper part and the lower part perpendicularly to the longitudinal axis;
a bundle of evaporators transporting hot water and comprising a plurality of evaporator elements extending along the longitudinal axis, the evaporator elements forming columns extending along the transverse axis, each column adjacent to two other columns being referred to as an interior column and each column adjacent to only one other column being referred to as an end column;
a sprinkling system extending above the bundle of evaporators in the upper part of the evaporator body and adapted to sprinkle the working fluid in liquid state onto the bundle of evaporators in order to evaporate this working fluid;
a casing covering the bundle of evaporators and the sprinkling system, an evacuation area being formed between the end columns and the casing; and
a redistribution system configured to collect the working fluid in liquid state in the evacuation area and to direct it towards the interior columns.

2. The evaporator according to claim 1, wherein the redistribution system comprises a plurality of flexed sheets, each sheet comprising a first part extending transversely along the transverse axis and a second part flexed relative to the first part and directed toward the interior columns.

3. The evaporator according to claim 2, wherein the first part of each sheet forms an angle greater than 90° and less than 180° with the second part of the same sheet.

4. The evaporator according to claim 2, wherein at least one of the first part or the second part of each sheet is substantially planar.

5. The evaporator according to claim 2, wherein:
the bundle of evaporators further comprises support bars adjacent to each end column and extending along the longitudinal axis; and
at least one sheet further comprises a third part configured to secure the sheet to one of the support bars.

6. The evaporator according to claim 5, wherein the third part of the corresponding sheet metal is located in extension of the first part opposite the second part.

7. An evaporator according to claim 2, wherein:
the casing forms a side wall adjacent to each end column, each sheet metal being adjacent to one of the side walls of the casing; and
the first part of each sheet metal is integral with or forms at least part of the corresponding side wall of the casing.

8. The evaporator according to claim 7, wherein the first parts of the metal sheets form the side walls of the casing.

9. The evaporator according to claim 2, wherein each sheet extends longitudinally along the longitudinal axis throughout the evaporator elements of the bundle of evaporators.

10. The evaporator according to claim 2, wherein for each end column, a plurality of sheets are arranged one after the other along the transverse axis, the second parts of these sheets being substantially parallel to one another.

11. The evaporator according to claim 5, wherein the third part forms a means for hooking the sheet to the corresponding support bar.
